(19) United States
(12) Patent Application Publication
(10) Pub. No.: US 2010/0046334 A1
(43) Pub. Date: Feb. 25, 2010

(54) RECORDING METHOD, RECORDING MEDIUM AND STORAGE DEVICE

(75) Inventor: Mitsuhiko Ohta, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/476,920

(22) Filed: Jun. 2, 2009

(30) Foreign Application Priority Data
Aug. 20, 2008 (JP) 2008-212255

(51) Int. Cl. G11B 20/10

(52) U.S. Cl. 369/47.2; G9B/20.009

(57) ABSTRACT

A recording method includes multiplexing data and continuously recording multiplexed data in a continuous recording region of a recording medium having a random recording region, and recording management information about multiplexing and recording in the random recording region.

### CROSS-REFERENCE TO RELATED APPLICATION

This application is based upon and claims the benefit of priority of the prior Japanese Patent Application No. 2008-212255, filed on Aug. 20, 2008, the entire contents of which are incorporated herein by reference.

### FIELD

An aspect of embodiments discussed herein relates to a recording method, a recording medium and a storage device.

### BACKGROUND

A magnetic disk drive is used as a storage device in computer systems and various electronic devices. Thus, the magnetic disk drive is always required to be improved to have an increased storage capacity.

An increase in the storage capacity of the magnetic disk drive may be achieved by increasing the recording density on the magnetic disk. An increase in the recording density on the magnetic disk may be achieved by two methods. The first method increases the track density on the magnetic disk in the radial direction. The second method increases the bit density in the track direction (bit direction). The track density is described as TPI (Track Per Inch), and the bit density is described as BPI (Bit Per Inch).

There is a proposal to record data on the magnetic disk in one direction (for example, from the outer side of the magnetic disk to the inner side) in order to increase the track density TPI. The method of writing data in the one direction does not need a margin for side erase on both sides of the track. That is, it is enough to provide the margin for side erase on only one side of the track. It is thus possible to increase the track density.

There is another proposal as described in Japanese Laid-Open Patent Publication No. 2007-250054. This is intended to realize a large capacity of storage. According to this proposal, the recording density of the recording medium is determined based on the warranted number of times of rewriting, and information is recorded on the recording medium at the recording density thus determined.

### SUMMARY

According to an aspect of the present invention, there is provided a recording method including: multiplexing data and continuously recording multiplexed data in a continuous recording region of a recording medium having a random recording region; and recording management information about multiplexing and recording in the random recording region.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a hard disk recorder in accordance with an embodiment of the present invention;

FIG. 2 illustrates an exemplary recording region of a magnetic disk and exemplary timings for program recording;

FIG. 3 illustrates multiplexing of programs;

FIG. 4 illustrates a relation between LBA and programs;

FIG. 5 illustrates an exemplary table of management information;

FIG. 6 is a flowchart of a process for program multiplexing and recording and a process for writing the management information;

FIG. 7 is a flowchart of a process for reading program data recorded in a multiplexed fashion; and

FIG. 8 illustrates recording regions of a magnetic disk and exemplary timings for program recording in related art.

### DESCRIPTION OF EMBODIMENTS

First, a description will be given of art related to an aspect of the present invention.

The related art applies the magnetic disk drive capable of writing data in one direction to a hard disk recorder with multiple tuners.

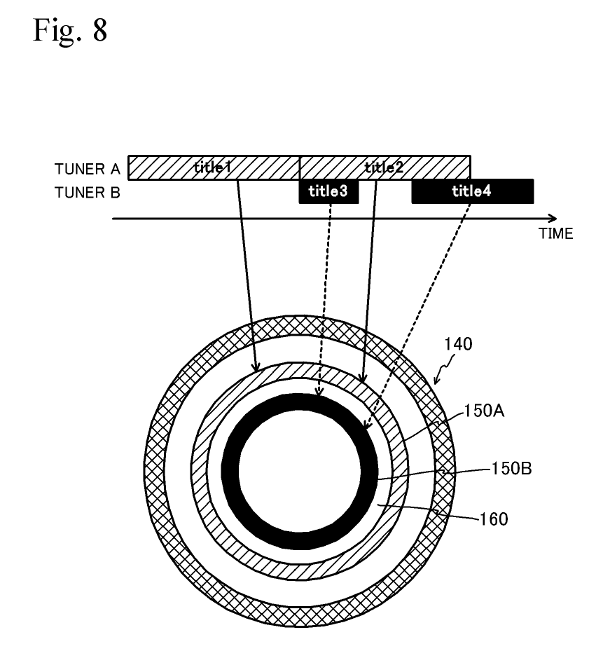

In this application, as illustrated in FIG. 8, the related art acquires storage regions 150A and 150B related to two tuners A and B on a magnetic disk 140, and records data thereon. In this recording, the related art handles a situation in which programs of tuners A and B are being simultaneously broadcasted in such a manner that one of the programs is recorded on the magnetic disk, and the other program is temporarily stored in a buffer. When recording of the program is completed, the program temporarily stored in the buffer is transferred to and recorded on the magnetic disk. Further, a reserve region 160 is needed between the storage regions 150A and 150B on the magnetic disk taking into account a situation in which it takes a long time to record the program of the tuner A.

However, the reserve region 160 may not be used in practical recording. The pre-established reserve region 160 may decrease the storage capacity of the magnetic disk. If the storage region 150A or 150B is fully used, there is a need to acquire anew storage region. Further, there is another need to acquire another reserve region along with the new storage region. This further decreases the storage capacity.

It is thus desired to realize high-density recording of multiple items of data.

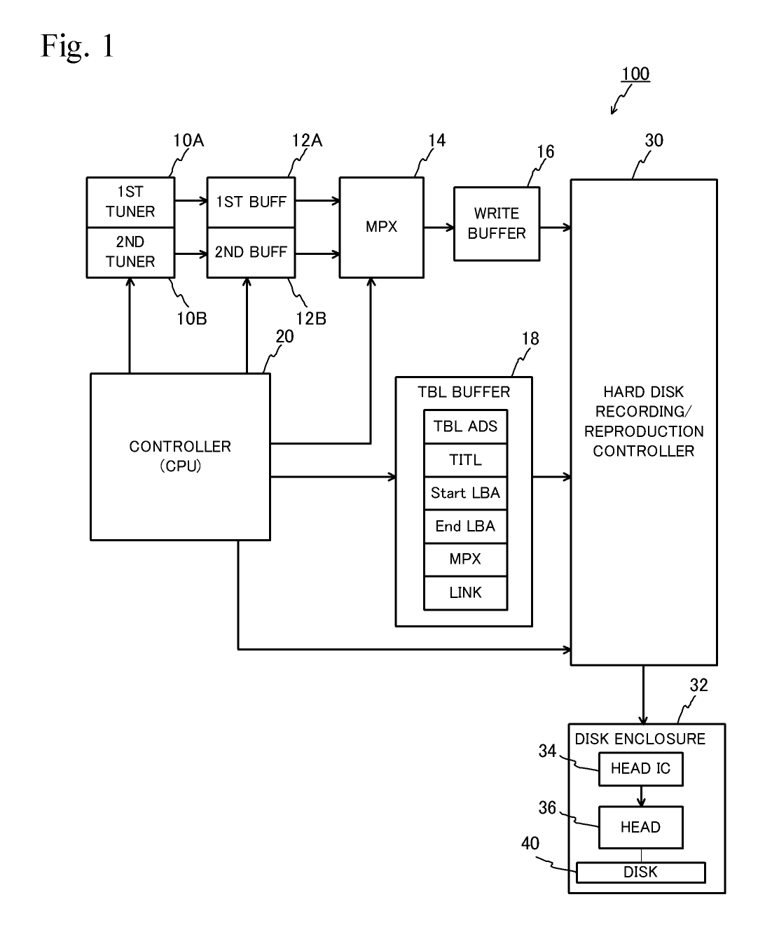

A description will now be given, with reference to FIGS. 1 through 7, of a recording method, a recording medium and a storage device in accordance with an embodiment of the present invention.

FIG. 1 is a block diagram of a hard disk recorder 100 that is an exemplary storage device. Referring to FIG. 1, the hard disk recorder 100 is composed of a first tuner 10A, a second tuner 10B, a first receive buffer 12A and a second receive buffer 12B, a multiplexer 14, a write buffer 16, a table (TBL) buffer 18, a hard disk recording/reproduction controller 30, a disk enclosure 32, and a controller 20. The hard disk recording/reproduction controller 30 may be a signal processing board. The controller 20, which may be a CPU, controls the entire operation of the hard disk recorder 100.

The first tuner 10A and the second 10B may be any types of tuners. In Japan, the first tuner 10A and the second tuner 10B may, for example, be any of a ground digital tuner, a ground analog tuner, a BS digital tuner, and a 110° CS digital tuner or an arbitrary combination thereof. The first tuner 10A and the second tuner 10B receive programs specified by the user through the controller 20. The programs may be specified with the titles thereof.

The first receive buffer 12A and the second receive buffer 12B are respectively associated with the first tuner 10A and the second turner 10B, and are used to temporarily store program data supplied from the first tuner 10A and the second tuner 10B. The sizes of the first and second receive buffers 12A and 12B depend on the unit of writing. For example, when writing is carried out at intervals of one second at a rate of 24 Mbps, the first and second receive buffers 12A and 12B are required to have a buffer size of 3 MB/s.

The multiplexer 14 receives the two data from the first and second receive buffers 12A and 12B and arranges the data in series under the control of the controller 20. In the present embodiment, the multiplexer 14 for multiplexing the two input data is required to operate at a rate or speed equal to twice that of these input data.

The write buffer 16 temporarily stores the data from the multiplexer 14. The write buffer 16 is required to operate at a rate equal to twice the rate of the input data of the multiplexer 14.

The table buffer 18 temporarily stores management information of program data generated by the controller 20. The management information of program data may be arranged in the form of a table. This will be described in more detail later.

The hard disk recording/reproduction controller 30 includes a hard disk controller (HDC), a read channel (RDC) and a motor driver, although these elements are not illustrated for the sake of simplicity.

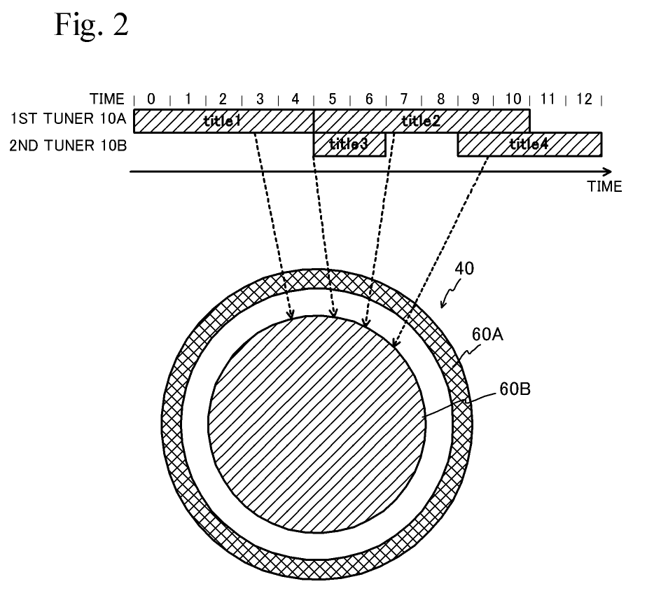

The disk enclosure 32 includes a head IC 34, a recording/reproduction element (head) 36, and a magnetic disk 40 (see FIG. 2), which is an exemplary recording medium. The data from the write buffer 16 and the table buffer 18 are received by the head IC 34 via the hard disk recording/reproduction controller 30. The head receives the data from the head IC 34 and records the received data on the magnetic disk 40 at a specified position.

In reproduction of data, the head 36 reads data from the magnetic disk 40 at a specified position and supplies the data to the head IC 34. Then, the head IC 34 sends the read data to the hard disk recording/reproduction controller 30, which reproduces the original images and/or audios from the read data and sends them to an external device such as a display (not shown).

A description will now be given, with reference to FIG. 2, of a method of recording data on the magnetic disk in accordance with an embodiment of the present invention.

Referring to FIG. 2, the magnetic disk 40 is divided into an outermost region 60A, and a region 60B including the central portion. The outermost region 60A is a random recording region in which data can be written repeatedly. In the following, the region 60A will be referred to as random recording region 60A. The region 60B is a continuous recording region in which data is allowed to be continuously written in only one direction. In the following, the region 60B will be referred to as continuous recording region 60B. The continuous recording region 60B is not divided or separated into regions assigned to the respective tuners. When the two programs of the first and second tuners 10A and 10B are simultaneously recorded, these programs are written in multiplexed recording in which the two programs are alternately recorded. The two programs may be divided and recorded in divided sectors in the continuous recording region 60B.

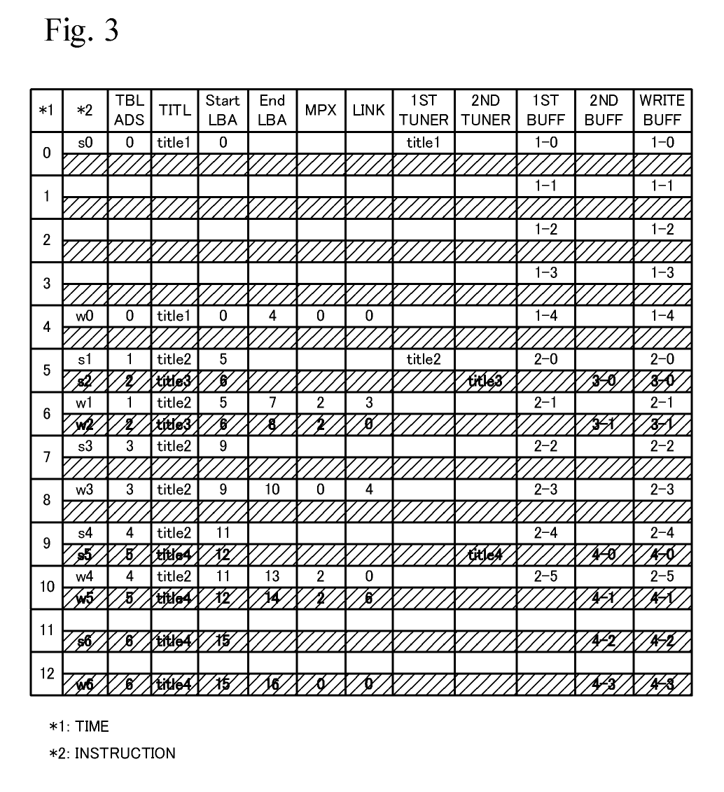

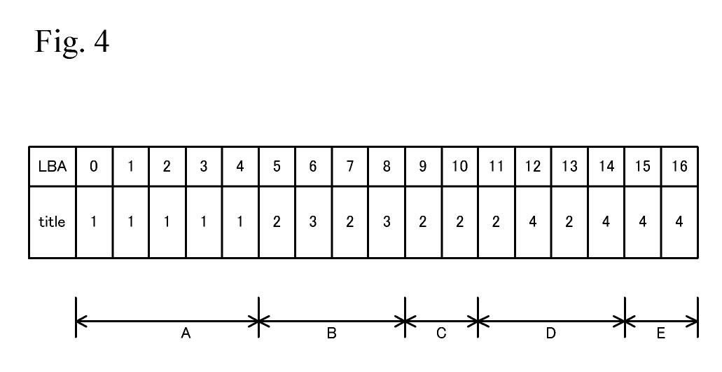

A description will now be given, with reference to FIGS. 3 and 4, of a process for recording the programs at timings illustrated in FIG. 2. In FIG. 2, two programs named title1 and title2 received by the first tuner 10A are continuously recorded in the continuous recording region 60B, and all of program named title3 and a part of program named title4 received by the second tuner 10B are recorded in the continuous recording region 60B in parallel with recording of title2. The order of recording the programs may be timer recording by the user.

FIG. 3 illustrates a table that describes various items on the time base. The items include instructions from the controller 20, the contents of the instructions, the contents of processes of the tuners 10A and 10B, and the contents of processes of the buffers 12A, 12B and 16. “Time” in the table means a unit time. For example, the unit time is designed so that one unit is equal to the time it takes to receive data equal to two sectors (2LBA: Logical Block Addressing) at maximum and record the data in the two sectors. Each of the rows at each of the unit times is vertically divided into two parts. The upper part (without hatching) indicates the contents of instructions and processes related to the first tuner 10A, and the lower part (with hatching) indicates the contents of instructions and processes related to the second tuner 10B. “Instructions” in the table describes the types of instructions given by the controller 20. A symbol “s” and “w” denote instructions to start and stop recording, respectively. A symbol “TBL ADS” denotes a table address assigned for each combination of (s, w). A symbol “TITL” denotes the title of program recorded. A symbol “Start LBA” denotes the LBA sector from which the recording starts. A symbol “End LBA” denotes the LBA sector with which the recording ends. A symbol “MPX” denotes whether multiplexing is employed and the hierarchical degree of multiplexing. A symbol “LINK” denotes whether there is a process that should be carried out consecutively after the process of a certain table address is finished and indicates the table address if any.

At times 0 through 4, the program title1 is received by the first tuner 10A and is recorded.

As illustrated in the table of FIG. 3, the program title1 is buffered in the first receive buffer 12A and the write buffer 16 on the write unit base (1-0, 1-1, 1-2, 1-3, 1-4), and is continuously recorded in the continuous recording region 60B of the magnetic disk 40 in one direction via the hard disk recording/reproduction controller 30 and the disk enclosure 32. In this case, the start LBA is “0” and the end LBA is “4” in an instruction w0 to end recording. Thus, the program title1 is continuously recorded in the range of LBA “0” to LBA “4”, as illustrated in section A in FIG. 4, which describes the relation between LBA and program (title).

At times 5 and 6, program title2 (equal to two sectors (2LBA)) using the first tuner 10A and program title3 (equal to 2LBA) are recorded in multiplexing.

In the above multiplexed recording, two programs title2 and title3 are alternately written in the continuous recording region 60B of the magnetic disk 40 in one direction on the single LBA base. As illustrated in FIG. 3, at time 5, a part of the program title2 equal to one LBA is recorded in the continuous recording region 60B and a part of the program title2 equal to one LBA is continuously recorded therein. At time 6, a subsequent part of the program title2 equal to one LBA is continuously recorded in the continuous recording region 60B and a subsequent part of the program title3 equal to one LBA is continuously recorded therein. As illustrated in section B in FIG. 4, the above parts of the program title2 are recorded in LBA “5” and LBA “7”, and the above parts of the program title3 are recorded in LBA “6” and LBA “8”. The above multiplexed recording is realized because the multiplexer 14 and the write buffer 16 operate at the rate equal to twice the rate of the input data.

At times 7 and 8, the recording of only the program title2 using the first tuner 10A is carried out. This recording is not multiplexed recording. Thus, the program title2 is continuously recorded in LBA “9” and LBA “10” of the magnetic disk 40 in one direction, as illustrated in section C in FIG. 4.

At times 9 and 10, the program title2 (equal to 2LBA) using the first tuner 10A and the program title4 (equal to 2LBA) using the second tuner 20A are recorded in multiplexing. In this case, the two programs title2 and title4 are alternately recorded in LBA “11” through LBA “14” of the continuous recording region 60B in one direction (see (2-4, 4-0, 2-5, 4-1) in the column of the write buffer in FIG. 3 and see section D in FIG. 4).

At times 11 and 12, only the program title4 (equal to 2LBA) using the second turner 10B is recorded. This recording is not multiplexed recording, the program title4 is continuously recorded in LBA “14” and LBA “15” in the continuous recording region 60B of the magnetic disk 40 in one direction (see section E in FIG. 4). A description will now be given of management information (table) generating during the process illustrated in FIGS. 3 and 4.

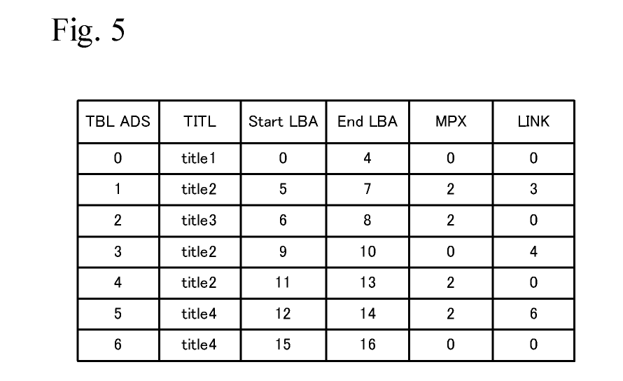

FIG. 5 illustrates exemplary management information arranged in a table. The management information manages multiple programs (data) assigned to the divided sectors formed in the continuous recording region 60B of the magnetic disk 40. More particularly, the table depicted in FIG. 5 may be formed by extracting, from the table of FIG. 3, given items “TBL ADS”, “TITL”, “Start LBA”, “End LBA”, “MPX” and “LINK” obtained when the instructions to end recording w0-w6 are issued.

The contents of the table illustrated in FIG. 5 are recorded in (or updated) the random recording region 60A of the magnetic disk 40 via the table buffer 18 under the control of the controller 20 on the table address base.

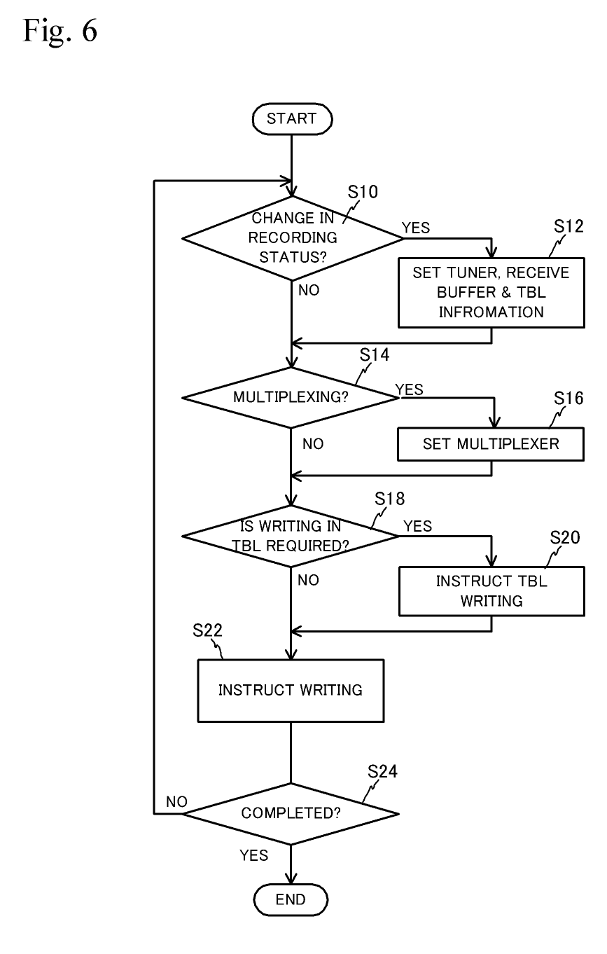

A description will now be given, with reference to a flowchart of FIG. 6, of the processes related to FIGS. 3 and 4 and a process of recording the management information formed in the table on the magnetic disk 40. The following process is executed by the controller 20.

The flowchart of FIG. 6 starts when the controller 20 confirms the status of timer recording and issues an instruction to start recording to the structural parts 10A, 12A, 14, 16 and 30 at time 0.

At step S10, the controller 10 determines whether there is a change in the recording status. It is noted that a change in the recording status takes place when the instruction to start recording or the instruction to end recording is issued. In the example of concern, the instruction (s0) to start recording the program title1 is issued at time 0. Thus, the answer of step S10 is YES, and the process proceeds to step S12. At step S12, the controller 20 carries out the settings of tuner and receive buffers, and updates the table information. At the stage of time 0, the first tuner 10A is set to the program title1, and sets the receive buffer 12A accordingly. The table information (management information) is associated with the instruction (w) to end recording. Thus, the table information is not updated when the instruction (s) to start recording is issued.

Step S12 is followed by step S14 at which the controller 20 determines whether multiplexing should be performed. At time 0, multiplexing is needed and the answer of step S14 is NO. Then, the controller 20 proceeds to step S18.

The controller 20 determines whether table writing should be carried out. The table writing is needed when the instruction to end the recording (any of w0 through w6) is issued. At the present stage, the instruction to end the recording has not yet been issued, and the answer of step S18 is NO. Then, the controller 20 proceeds to step S22.

At step S22, the controller 20 issues an instruction to record data buffered in the write buffer 16 on the magnetic disk 40 via the hard disk recording/reproduction controller 30 and the disk enclosure 32.

Then, the controller 20 proceeds to step S24 when data has been recorded on the magnetic disk 40, and determines whether all the processes have been processed. The controller 20 refers to the status of timer recording. When it is determined that the process should be continuously carried out, the answer of step S24 is NO, and the process returns to step S10.

At time 1, the controller 20 executes the process illustrated in FIG. 6. In this case, there is no change in the recording status, and no multiplexing is needed. Further, there is no need to perform table writing. Thus, at step S22, the controller 20 issues only an instruction to write data buffered in the write buffer 16 in the magnetic disk 40, and returns to step S10. Then, the controller 20 repeatedly carries out the above process until time 3.

At time 4, the controller 20 issues an instruction w0 to stop recording, and the answer of step S10 is YES. In this case, the controller 20 carries out the settings of first tuner 10A and the first receive buffer 12A, and updates the contents of TBL ADS “0” in the table information (see FIG. 5). Further, the answer of step S18 is YES at time 4. At step S20, the controller 20 issues an instruction to write the table information to the table buffer 18 and the hard disk recording/reproduction controller 30. Thus, the table information (information on TBL ADS “0”) is written in the random recording region 60A of the magnetic disk 40. At step S22, the program title1 is recorded, and the process returns to step S10.

At time 5, instructions s1 and s2 to start recording the programs title2 and title3 are issued and the recording status is changed. Thus, the answer of step S10 is YES. In this case, the controller 20 moves to step S134 via step S12.

At step S14, the controller 20 determines whether multiplexing should be performed. In this case, two programs title2 and title3 should be recorded, and the answer of step S16 is YES. The controller 20 sets the multiplexer 14 so that the programs title2 and title3 are alternately recorded on the LBA base. At step S22, the controller 20 writes the programs title2 and title3 in the continuous recording region 60B of the magnetic disk 40 in one direction through the determination of step S18 (here the answer is NO).

Then, the answer of step S24 is NO, and the process returns to step S10.

At time 6, the controller 20 issues instructions w1 and w2 to stop recording the programs title2 and title3. Thus, the recording status is changed, and the answer of step S10 is YES. In this case, the controller 20 proceeds to step S14 via step S12.

At step S14, the controller 20 determines whether multiplexing should be performed. In the present case, the two programs title2 and title3 are recorded, and the answer of step S14 is YES. At step S16, the controller 20 sets the multiplexer 14 so that the programs title2 and title3 are alternately written on the LBA base. When the answer of step S18 is affirmative, the controller 20 issues an instruction to write the table information to the table buffer 18 and the hard disk recording/reproduction controller 30. Thus, new table information (TBL ADS “1” and TBL ADS “2”) is written in the random recording region 60A.

At step S22, the controller 20 issues instructions to write the programs title2 and title3 in one direction in multiplexing, and returns to step S10 when the answer of step S24 is NO.

The above-mentioned process is repeatedly carried out until time 12 at which the timer recording ends. Thereafter, the answer of step S24 becomes YES, and all the process illustrated in FIG. 6 is completed.

Thus, as shown in FIG. 4, data are continuously multiplexed and are written in the LBA sectors of the continuous recording region 60B depicted in FIG. 2, while the management information illustrated in FIG. 5 arranged in the table is written in the random recording region 60A.

When the programs recorded in the continuous recording region 60B of the magnetic disk 40 are continuously rewritten, the process illustrated in FIG. 6 is carried out again. Further, the management information regarding the data to be written is updated and is written in the random recording region 60A.

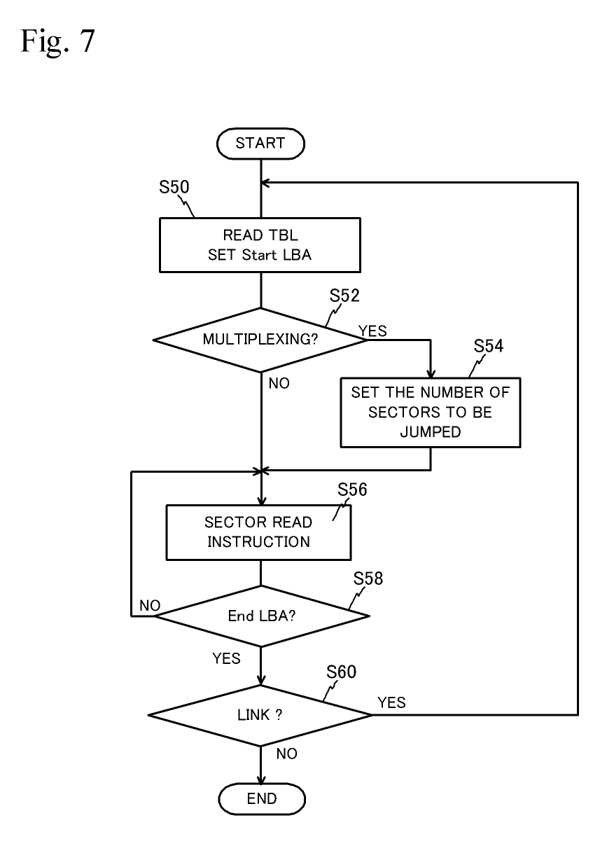

A description will now be given, with reference to FIG. 7, of a process of reading the program recorded on the magnetic disk 40. The controller 20 executes a process depicted in FIG. 7.

When a program is specified by the user, who may applies the title of the program to the hard disk recorder 100, the controller 20 reads the management information described in the form of table from the random recording region 60A of the magnetic disk 40, and sets “Start LBA” on the basis of the program specified. For example, when the user specifies the program title2 for reproduction, the controller 20 extracts items about only the program title2 from the table and sets “Start LBA” involved in reproduction. More specifically, the smallest value of “Start LBA” related to the program title2. In the table of FIG. 5, the controller 20 sets “Start LBA” to “5” for TBL ADS of “1”.

At step S52, the controller 20 refers to “MPX2 in the table of FIG. 5 and determines whether the program title2 includes multiplexing. In the present example, MPX for TBL ADS “0” is “2”, and the program title2 includes multiplexing. Thus, the answer of step S52 is YES, and the controller proceeds to step S54.

At step S54, the controller 20 sets the number of sectors to be jumped. Here, the controller 20 sets the number of sectors to be jumped equal to 1. Thus, Start LBA “5” to End LBA “7” is read every other sector so that LBA “6” is jumped.

At subsequent step S56, the controller 20 issues an instruction to read data from the sector (in the present example, from the sector associated with LBA “5”), and proceeds to step S58. At step S58, the controller 20 determines whether the current sector is End LBA. In the present example, the answer is NO, and the process returns to step S56. Then, the controller issues an instruction to jump one sector (LBA “6”) and read data from the sector (LBA “7”) following the jumped sector.

At step S58, the controller 20 determines whether the current sector is End LBA. Here, the read LBA is “7”, which coincides with “7” of End LBA. Thus, the answer of step S58 is YES, and the process returns to step S50.

At step S60, the controller 20 refers to LINK and determines whether there is a process that should be carried out consecutively. In the present example, LINK for TBL ADS of “1” in the table of FIG. 5 is “3”. Thus, the answer of step S60 is YES, and the process returns to step S50.

At step S50, the controller 20 reads data with TBL ADS “3” in a manner similar to the above. It is to be noted that MPX is “0” for TBL ADS “3” in the table of FIG. 5. Thus, it is not required to set the number of sectors to be jumped. Thus, the controller 20 issues an instruction to read all of LBA sectors from Start LBA “9” to End LBA “10” (step S56).

At step S60, the controller 20 refers to LINK and determines whether there is a process that should be carried out consecutively. In the present example, LINK for TBL ADS “3” is “4” in the table of FIG. 5. Thus, the answer of step S60 is YES, and the process returns to step S50.

At step S50, the controller 20 reads data with TBL ADS “4” in a manner similar to the above. In the present example, MPX is “2” for TBL ADS “4” in the table of FIG. 5. Thus, the controller 20 sets the number of sectors to be jumped equal to 1 and issues an instruction to read the sectors from Start LBA “11” to End LBA “13” every other sector. When this reading is completed, the controller 20 determines whether there is a process that should be carried out consecutively. In the present example, LINK for TBL ADS “4” is “0” in the table of FIG. 5. Thus, the answer of step S60 is NO, and the process illustrated in FIG. 7 is finished.

The above-mentioned read process makes it possible to easily access data multiplexed and recorded on the continuous recording region 60B of the magnetic disk 40 in one direction.

According to the present embodiment, multiple items of data (for example, programs) are continuously multiplexed and recorded in the continuous recording region 60B. It is thus possible to simultaneously write the multiple items of data in the continuous recording region 60B in which data can be written at a high density. The management information (FIG. 5) about multiplexing is recorded in the random recording region 60A. It is thus possible to access the multiplexed and recorded data by referring to the management information. Thus, the present embodiment realizes high-density recording of multiple items of data and efficient reproduction.

According to the present embodiment, multiplexing is implemented by dividing multiple items of data and assigning divided items of data to divided sectors formed in the continuous recording region 60B. This is quite different from the related art in which each tuner is assigned the respective recording region, and the reserve region is provided for each recording region. The present embodiment is capable of securing a greater storage capacity than the related art.

In the present embodiment, the management information arranged in the table of FIG. 5 relates to the programs assigned to the divided sectors formed in the continuous recording region 60B. It is thus possible to easily specify or follow the divided sectors to which the program to be read is assigned by referring to the management information.

In the present embodiment, data is recorded in the continuous recording region 60B in one direction. It is thus possible to determine the track pitch by considering only the side erase provided on one side of the track. This makes it possible to set the track pitch in the continuous recording region 60B less than the track pitch in the random recording region 60A and to obtain an increased recording density at which the programs are recorded.

According to the present embodiment, when the program data recorded in the continuous recording region 60B of the magnetic disk 40 is replaced with another program data, the management information about the program data to be written is recorded in the random recording region 60A. Since the management information is updated each time rewriting of program is carried out, it is possible to reliably read the rewritten program data from the continuous recording region 60B.

According to the present invention, as indicated in FIGS. 2 and 5, the management information is updated when the number of programs to be multiplexed changes. Thus, there is no need to update the management information frequently, so that the management information can be handled without heavy load.

The present embodiment may be varied so that the continuous recording region 60B of the magnetic disk 40 is a write-once region.

The hard disk recorder 100 is not limited to the use of two tuners 10A and 10B but may have three tuners or more. It is possible to multiplex and record the programs or more in a manner similar to the above-mentioned manner.

The storage device of the above-mentioned embodiment may be applied to not only the hard disk recorder but also a hard disk drive. The hard disk drive is capable of simultaneously handling multiple applications by the above-mentioned method.

In the present embodiment, the random recording region 60A is provided on the outer side of the magnetic disk 40, and the continuous recording region 60B is further in than the random recording region 60A. The present invention is not limited to this arrangement, but the regions 60A and 60B may be arranged at arbitrary positions on the magnetic disk 40.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A recording method comprising:
multiplexing data and continuously recording multiplexed data in a continuous recording region of a recording medium having a random recording region; and
recording management information about multiplexing and recording in the random recording region.

2. The recording method according to claim 1, wherein multiplexing includes dividing the data and assigning divided parts of the data to sectors formed in the continuous recording region.

3. The recording method according to claim 1, wherein the management information manages the multiplexed data recorded in the continuous recording region.

4. The recording method according to claim 1, wherein the continuous recording region ahs a track pitch less than that of the random recording region.

5. The recording method according to claim 1, wherein, when the multiplexed data are replaced by new data by multiplexing the new data and continuously recording multiplexed new data in the continuous recording region, the management information is updated to manage the multiplexed new data in the continuous recording region.

6. A recording medium comprising:
a continuous recording region in which data are multiplexed and are continuously recorded; and
a random recording region in which management information about multiplexing and recording is recorded.

7. A storage device comprising:
a recording medium;
a recording/reproduction element recording and reproducing data on and from the recording medium; and
a signal processing board that controls the recording/reproduction element.
